(19) United States
(12) Patent Application Publication
(10) Pub. No.: US 2010/0097032 A1
(43) Pub. Date: Apr. 22, 2010

(54) CHARGING DEVICE AND PORTABLE ELECTRONIC DEVICE EMPLOYING THE SAME

(75) Inventor: MENG-CHIEH CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/558,746

(22) Filed: Sep. 14, 2009

(30) Foreign Application Priority Data
Oct. 17, 2008 (CN) 200810304975.8

(51) Int. Cl. H02J 7/00

(52) U.S. Cl. 320/114

(57) ABSTRACT

A charging device includes an electric energy generating unit, and a voltage regulating unit electrically connected to the electric energy generating unit and a battery. The electric energy generating unit is configured for converting kinetic energy into electric energy and outputs a voltage. The voltage regulating unit receives the electric energy and regulates the voltage output by the electric energy generating unit into a stable operating voltage, then the electric energy is output to be stored or charge the battery.

### CROSS-REFERENCE TO RELATED APPLICATIONS

This application is related to a co-pending U.S. patent application (Attorney Docket No.: US22974), entitled “CHARGING DEVICE, PORTABLE ELECTRONIC DEVICE EMPLOYING THE SAME, AND CHARGING METHOD THEREOF”, by Hsing-Yuan Hsieh. This application has the same assignee as the present application. The above-identified application is incorporated herein by reference.

### BACKGROUND

1. Technical Field

The disclosure generally relates to charging devices, particularly, to a charging device for a portable electronic device.

2. Description of Related Art

Portable electronic devices, such as mobile telephones and personal digital assistants (PDAs), generally are equipped with chargeable batteries. When battery power is low or empty, a power source is required to charge the battery.

However, when power sources are not available, the portable electronic device may not be conveniently recharged. In addition, the charger is usually a separate component from the portable electronic device.

Therefore, there is room for improvement within the art.

### BRIEF DESCRIPTION OF THE DRAWINGS

Many aspects of a charging device and a portable electronic device employing the same can be better understood with reference to the following drawings. The components in the drawings are not necessarily to scale, the emphasis instead being placed upon clearly illustrating the principles of the present charging device and a portable electronic device employing the same. Moreover, in the drawings, like reference numerals designate corresponding parts throughout the several views.

FIG. 1 is a block diagram of a charging device charging a battery, according to an exemplary embodiment.

FIG. 2 is a schematic view of a portable electronic device with the charging device shown in FIG. 1.

FIG. 3 is a block diagram of a charging device charging a battery, according to another embodiment.

FIG. 4 is a schematic view of a portable electronic device with the charging device shown in FIG. 3.

### DETAILED DESCRIPTION OF THE EMBODIMENTS

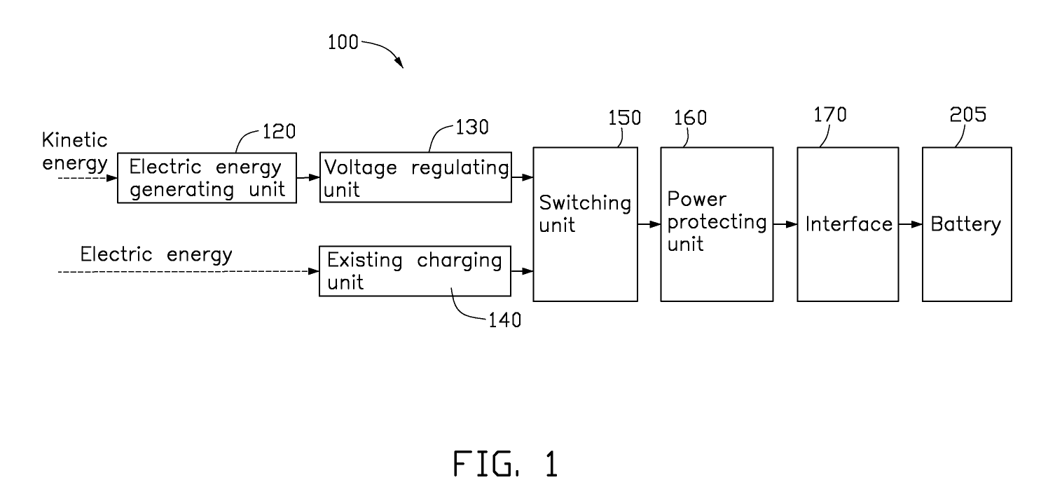

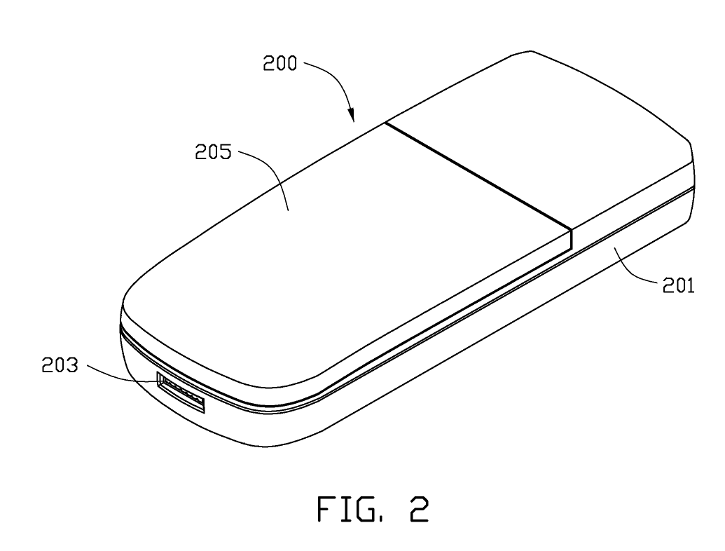

FIGS. 1-2 show an exemplary embodiment of a charging device 100 used to charge a portable electronic device 200, such as a mobile phone. The charging device 100 is installed in the portable electronic device 200. The mobile phone is taken here as an exemplary application, for the purposes of describing details of the charging device 100. The portable electronic device 200 includes a housing 201, a charging socket 203, and a battery 205. The charging socket 203 is formed at one end of the housing 201 for electronically connecting with the charging device 100. The battery 205 is mounted in the housing 201 configured for supplying electric energy to the portable electronic device 200.

Referring to FIG. 1, the charging device 100 is configured for using two charging modes, a common charging mode and a kinetic energy charging mode. The charging device 100 includes an electric energy generating unit 120, a voltage regulating unit 130 electrically connected to the electric energy generating unit 120, an existing charging unit 140, a switching unit 150, a power protecting unit 160, and an interface 170. The power protecting unit 160 is electrically connected to the battery 205 via the interface 170 to charge the battery 205.

The electric energy generating unit 120 can use an existing G-sensor, which can convert kinetic energy into electric energy, an output current and a voltage. The converted energy by the electric energy generating unit 120 may be not stable enough to directly charge the battery 205. Therefore, the voltage regulating module 130 is configured for converting and regulating the unstable voltage from the electric energy generating unit 120 into a stable operating voltage capable of charging the battery 205.

The existing charging unit 140 is configured to apply the common charging mode to charge the battery 205. The existing charging unit 140 can be electrically connected to the 110 volts or the 200 volts power source, and can regulate the voltage from the power source to charge the battery 205.

The switching unit 150 is electrically connected to the voltage regulating unit 130 and the existing charging unit 140. The switching unit 150 is configured to switch on the common charging mode or the kinetic energy charging mode to charge the battery 205. The switching unit 150 can be a switch on the portable electronic device 200 or a software program to manually switch between charging modes as described above. For example, when the existing charging unit 140 is connected to the power source, then the switching unit 150 receives a detecting signal and automatically switches the existing charging unit 140 on. When the existing charging unit 140 is disconnected with the power source, then the switching unit 150 automatically switches the voltage regulating unit 130 on to supply electric energy for the battery 205.

The power protecting unit 160 is electrically connected to the switching unit 150. The power protecting unit 160 is configured for preventing the battery 205 damage due to abnormal states, such as overcharging, overvoltage, short circuit, overheating, etc. When any abnormal state of the charging device 100 and the battery 205 occurs, the power protecting unit 160 can detect the abnormal commands and stop charging the battery 205 via the interface 170.

In use, when the existing charging unit 140 is electrically connected to a power source, the charging device 100 is in the common charging mode, the switching unit 150 switches the existing charging unit 140 on, then the charging device 100 can use the power source to charge the battery 205. When the existing charging unit 100 is disconnected with the power source, the charging device 100 is in the kinetic energy charging mode, the switching unit 150 automatically switches the voltage regulating unit 130 on, then the electric energy generating unit 120 converts kinetic energy into electric energy, and the voltage regulating unit 130 converts the unstable voltage from the electric energy generating unit 120 into a stable operating voltage capable of charging the battery 205. The power protecting unit 160 protects the battery 205 from being damaged due to any abnormal states.

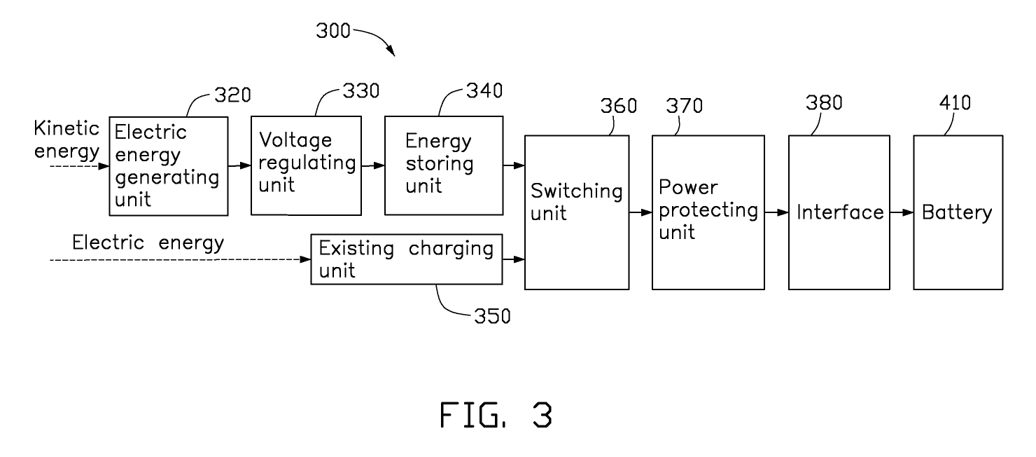

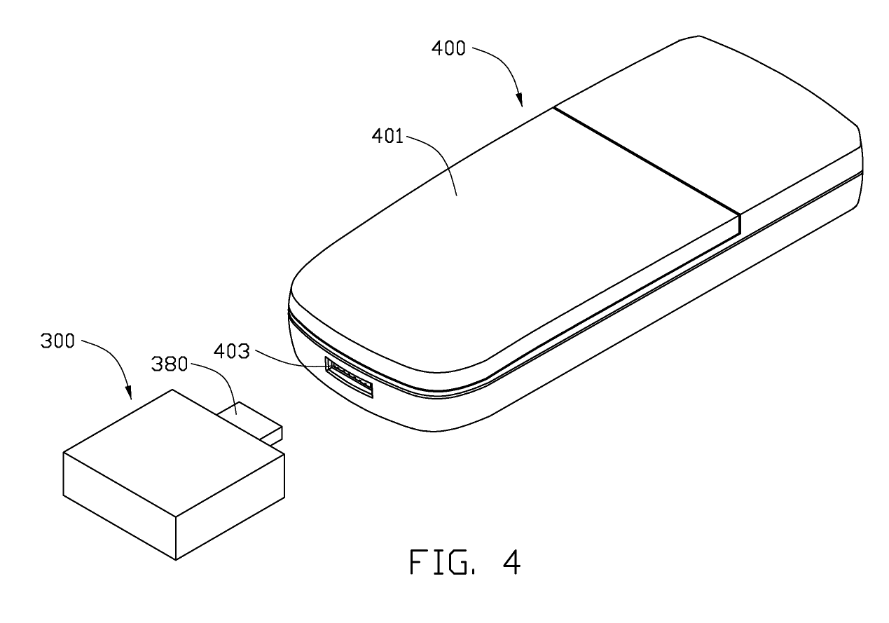

The charging device may be directly mounted to the portable electronic device. Referring to FIGS. 3-4, an independent charging device 300 can be mounted to a portable electronic device 400. The charging device 300 includes an electric energy generating unit 320, a voltage regulating unit 330, an energy storing unit 340, an existing charging unit 350, a switching unit 360, a power protecting unit 370, and a plug 380. The electric energy generating unit 320, the voltage regulating unit 330, the energy storing unit 340, the switching unit 360, the power protecting unit 370, and the plug 380 are electrically connected in series. The existing charging unit 350, the switching unit 360, the power protecting unit 370, and the plug 380 are electrically connected in series. The portable electronic device 400 includes a battery 401 and a charging socket 403 formed at one end of the portable electronic device 400.

The electric energy generating unit 320, the voltage regulating unit 330, the existing charging unit 350, the switching unit 360, the power protecting unit 370, the plug 380, and the portable electronic device 400 have substantially the same configuration as those of the charging device 100 and the portable electronic device 200 as shown in FIGS. 1-2. The energy storing unit 340 is capable of storing electric energy, and supplies electric energy when power sources may be not available. The interface 170 is set in the plug 380 thereof. When the plug 380 engages with the charging socket 403, the charging device 300 is electrically connected to the battery 401 via the plug 380.

Another battery can be set in the charging device 100 to be used as the energy storing unit 340. In practical applications, the charging device can charge the battery, and can also store and supply electric energy to prolong use time of the battery.

It is to be understood that the plug 380 may be an universal asynchronous receiver/transmitter (UART), an universal serial bus (USB) etc.

The charging device have a common charging mode and a kinetic energy charging mode and can use kinetic energy and the existing power source to charge the battery. The charging device is convenient to operate and can store electric energy and charge the battery when necessary.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A charging device for charging a battery, comprising:
an electric energy generating unit comprising a G-sensor, the G-sensor configured for converting kinetic energy into electric energy, and outputting a voltage; and
a voltage regulating unit electrically connected to the electric energy generating unit and the battery, wherein the voltage regulating unit receives the electric energy and regulates the voltage output by the electric energy generating unit into a stable operating voltage, the electric energy output to charge the battery.

2. The charging device as claimed in claim 1, wherein further comprising an existing charging unit and a switching unit, wherein the existing charging unit is electrically connected to a power source and configured for charging the battery, the switching unit is electrically connected to the voltage regulating unit and the existing charging unit, and configured for switching on the voltage regulating unit or the existing charging unit.

3. The charging device as claimed in claim 2, further comprising an energy storing unit electrically connected to the voltage regulating unit and the switching unit, wherein the energy storing unit is configured for storing electric energy and supplying electric energy for the battery.

4. The charging device as claimed in claim 3, further comprising a power protecting unit electrically connected to the switching unit and the battery, wherein the power protecting unit is configured for controlling and protecting the battery.

5. A charging device, comprising:
an electric energy generating unit configured for converting kinetic energy into electric energy, and outputting a voltage;
a voltage regulating unit electrically connected to the electric energy generating unit and a battery, the voltage regulating unit configured for regulating the voltage output by the electric energy generating unit into a stable operating voltage;
an existing charging unit electrically connected to power source and charging the battery; and
a switching unit electrically connected to the voltage regulating unit, the existing charging unit, and the battery, wherein the switching unit is configured for choosing a common charging mode or a kinetic energy charging mode.

6. The charging device as claimed in claim 5, wherein the electric energy generating unit comprises a G-sensor configured for converting kinetic energy into electric energy.

7. The charging device as claimed in claim 5, further comprising an energy storing unit electrically connected to the voltage regulating unit, the energy storing unit is configured for storing electric energy and supplying electric energy for the battery.

8. The charging device as claimed in claim 7, further comprising a power protecting unit electrically connected to the energy storing unit and the battery, the power protecting unit is configured for controlling and protecting the battery.

9. The charging device as claimed in claim 8, wherein when the switching unit chooses the kinetic energy charging mode to charge the battery, the electric energy generating unit converts kinetic energy into electric energy, and the voltage regulating unit and the power protecting unit regulate and control the electric energy to charge the battery.

10. The charging device as claimed in claim 8, wherein when the switching unit chooses the common charging mode to charge the battery, the existing charging unit is electrically connected to the power source, and the voltage regulating unit and the power protecting unit regulate and control the electric energy to charge the battery.

11. The charging device as claimed in claim 5, wherein the switching unit can manually or automatically choose the kinetic energy charging mode or the common charging mode to charge the battery.

12. A portable electronic device, comprising:
a housing;
a battery mounted to the housing, the battery supplying electric energy for the portable electronic device; and
a charging device mounted with the housing, the charging device comprising:
an electric energy generating unit configured for converting kinetic energy into electric energy, and outputting a voltage;
a voltage regulating unit electrically connected to the electric energy generating unit and the battery, the voltage regulating unit configured for regulating the voltage output by the electric energy generating unit into a stable operating voltage;
an existing charging unit electrically connected to power source and charging the battery; and
a switching unit electrically connected to the voltage regulating unit, the existing charging unit, and the battery, wherein the switching unit is configured for choosing a common charging mode or a kinetic energy charging mode to charge the battery.

13. The portable electronic device as claimed in claim 12, the electric energy generating unit comprises a G-sensor configured for converting kinetic energy into electric energy.

14. The portable electronic device as claimed in claim 12, wherein the charging device further comprises an energy storing unit electrically connected to the voltage regulating unit, the energy storing unit is configured for storing electric energy and supplying electric energy for the battery.

15. The portable electronic device as claimed in claim 14, wherein the charging device further comprises a power protecting unit electrically connected to the energy storing unit and the battery, the power protecting unit is configured for controlling and protecting the battery.

16. The portable electronic device as claimed in claim 15, wherein when the switching unit chooses the kinetic energy charging mode to charge the battery, the electric energy generating unit converts kinetic energy into electric energy, and the voltage regulating unit and the power protecting unit regulate and control the electric energy to charge the battery.

17. The portable electronic device as claimed in claim 15, wherein when the switching unit chooses the common charging mode to charge the battery, the existing charging unit is electrically connected to the power source, and the voltage regulating unit and the power protecting unit regulate and control the electric energy to charge the battery.

18. The portable electronic device as claimed in claim 12, wherein the switching unit can manually or automatically choose the kinetic energy charging mode or the common charging mode to charge the battery.

19. The portable electronic device as claimed in claim 12, further comprising a charging socket formed at one end of the housing for electrically connected to the charging device.

20. The portable electronic device as claimed in claim 19, wherein the charging device further comprises a plug electrically connected to the power protecting unit, and the plug is matched with the charging socket to charge the battery.
